(19) United States
(12) Patent Application Publication
(10) Pub. No.: US 2025/0289506 A1
(43) Pub. Date: Sep. 18, 2025

(54) ANTI-FLUTTER BRACKETS FOR HOOD ASSEMBLIES OF VEHICLES

(71) Applicant: Toyota Motor Engineering & Manufacturing North America, Inc., Plano, TX (US)

(72) Inventors: Paxton S. Williams, Milan, MI (US); Brandon W. Letcher, New Hudson, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/607,869

(22) Filed: Mar. 18, 2024

(51) Int. Cl. B62D 25/12; B62D 25/10

(52) U.S. Cl. CPC B62D 25/12; B62D 25/105

(57) ABSTRACT

A hood assembly for a vehicle including a hood inner panel and an outer hood panel connected to the hood inner panel. An anti-flutter bracket includes a bracket body and an energy absorption material that is softer than the bracket body located between the outer hood panel and a first flat area of the bracket body that extends parallel to the outer hood panel.

### TECHNICAL FIELD

The present specification generally relates to front hood assemblies for vehicles and, more specifically, to front hood assemblies for vehicles with anti-flutter brackets for the front hood assemblies.

### BACKGROUND

Vehicles may be equipped with front hood assemblies including bumper assemblies and a front grille. Often, the front hood assemblies are formed of multiple panels that are connected together in some fashion. During operation of the vehicles, the panels of the hood assembly may vibrate and create noise. It is desirable to reduce the noise of the front hood assemblies due to the vibration.

### SUMMARY

In one embodiment, a hood assembly for a vehicle including a hood inner panel and an outer hood panel connected to the hood inner panel. An anti-flutter bracket includes a bracket body and an energy absorption material that is softer than the bracket body located between the outer hood panel and a first flat area of the bracket body that extends parallel to the outer hood panel.

In another embodiment, an anti-flutter bracket for controlling vibration within a hood assembly of a vehicle includes a bracket body and an energy absorption material that is softer than the bracket body and is configured to be located between an outer hood panel and a first flat area of the bracket body that is configured to extend parallel to the outer hood panel with the bracket body installed to an inner hood panel.

In another embodiment, a method of controlling vibration in a hood assembly of a vehicle is provided. The method includes connecting an anti-flutter bracket to an inner hood panel of the hood assembly. An energy absorption material carried by the anti-flutter bracket is braced against an outer hood panel of the hood assembly, the energy absorption material formed of a material that is softer than a bracket body that carries the energy absorption material.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a front end perspective view of a portion of a vehicle with a hood assembly positioned at a front of the vehicle, according to one or more embodiments shown and described herein;

FIG. 2 schematically depicts the hood assembly of FIG. 1 in isolation, according to one or more embodiments shown and described herein; and

FIG. 3 schematically depicts a section view of the hood assembly of FIG. 2 along line A-A, according to one or more embodiments shown and described herein.

### DETAILED DESCRIPTION

Embodiments described herein are directed to hood assemblies for vehicles that include anti-flutter brackets for controlling vibrational energy created between panels of the hood assemblies when the vehicles are operating. The hood assemblies include a hood inner panel and an outer hood panel connected to the hood inner panel. An anti-flutter bracket is provided that includes a bracket body and an energy absorption material that is softer than the bracket body located between the outer hood panel and a first flat area of the bracket body that extends parallel to the outer hood panel. The energy absorption material is adhered only to the bracket thereby allowing the anti-flutter bracket to move independently of the outer hood panel when there is thermal expansion of the outer hood panel. The bracket body including a second flat area with double sided adhesive tape and a pinch feature that together engage the hood inner panel.

In the embodiments described herein, the −x direction of the coordinate axes in the figures refers to a length direction. The +/−z direction of the coordinate axes in the figures refers to a vertical direction. The +/−y direction of the coordinate axes in the figures refers to a width direction. Reference will now be made in detail to embodiments of anti-flutter brackets, examples of which are illustrated in the accompanying drawings. Various embodiments of the energy absorber structure(s) will be described in more detail herein.

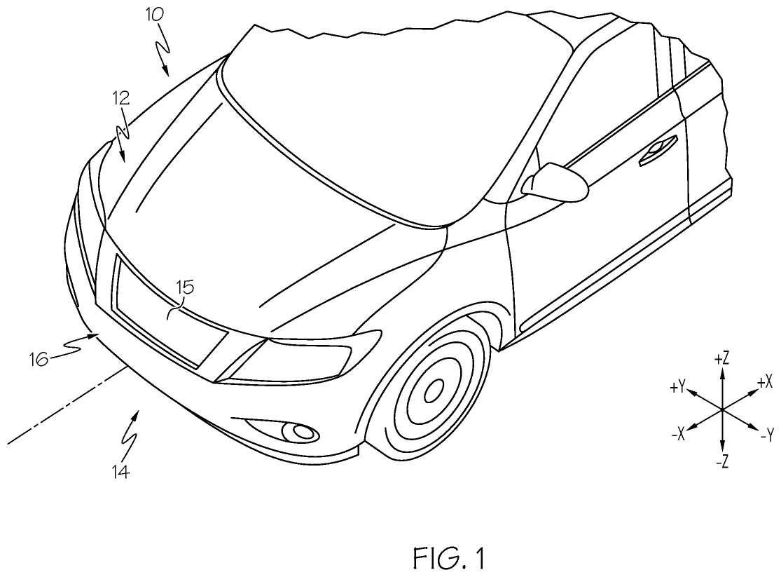

Referring now to FIG. 1, a front, perspective view of a portion of a vehicle 10 is schematically depicted. The vehicle 10 includes a hood assembly 12 at a front end portion 14 of the vehicle 10. The front end portion 14 includes a front grille 15 and a bumper assembly 16 coupled to and extending in a width direction of the front of the vehicle 10.

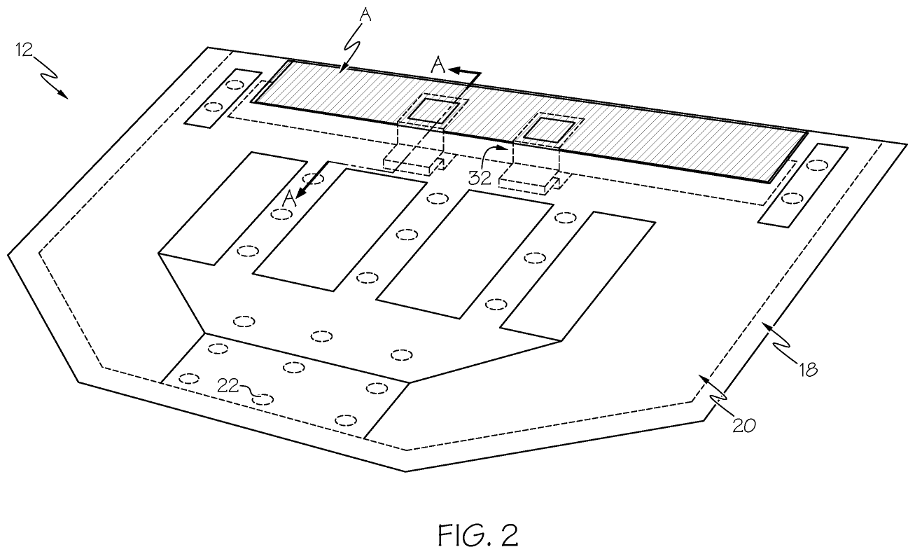

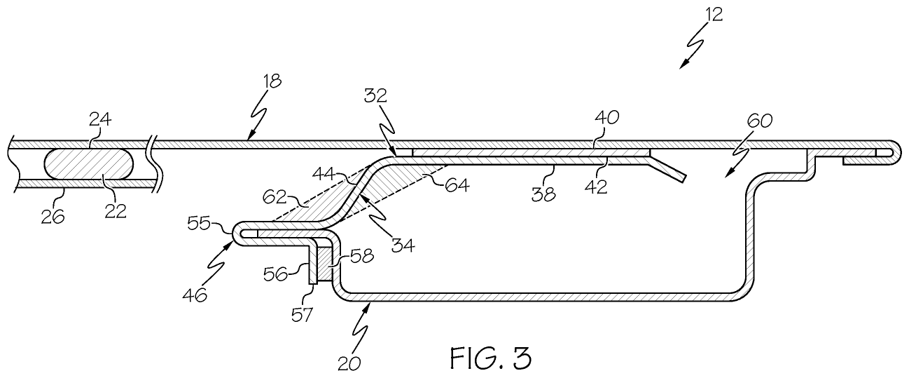

FIG. 2 illustrates the hood assembly 12 in isolation with the hood assembly 12 including an outer hood panel 18 and an inner hood panel 20 that is connected to the outer hood panel 18. Referring also to FIG. 3, an adhesive resin 22, such as mastic, may be placed between portions 24 and 26 of the outer hood panel 18 and the inner hood panel 20, respectively, which can help support the inner and outer hood panels 20 and 18 relative to one another and limit vibration between the two panels 20 and 18. However, with this arrangement, there is a rear area A, represented by hatching that remains unsupported between the inner and outer hood panels 20 and 18 and may be subject to vibrational energy. To control vibration between the inner and outer hood panels 20 and 18, an anti-flutter bracket 32 is provided. Referring particularly to FIG. 3, the anti-flutter bracket 32 includes a bracket body 34 that is connected to the inner hood panel 36. The bracket body 34 includes a longitudinally and laterally extending flat portion 38 having a first flat area that includes an energy absorption material 40, such as a felt, sponge, etc., located thereon between the bracket body 34 and the outer hood panel 18. The energy absorption material 40 may be formed of a material that is softer then material forming the bracket body 34 and may have only one side 42 that is covered with an adhesive to bond the energy absorption material 40 to the flat portion 38 and not to the outer hood panel 18. While adhesive bonding may be used to bond the energy absorption material 40 to the flat portion 38, any other suitable bonding method may be used, such as welding.

Thermal expansion of the outer hood panel 18 and the inner hood panel 20 may be different under certain conditions because the outer hood panel 18 is directly exposed to the sun and the inner hood panel 20 is not. The inner hood panel 20 is closer to the engine, which can be hot, while the outer hood panel 18 is not exposed directly to the hot engine. Bonding the energy absorption material 40 only to the flat portion 38 and not to the outer hood panel 18 accounts for these differences in thermal expansion between the outer and inner hood panels 18 and 20 when they occur.

The bracket body 34 further includes a slanted portion 44 that slants away from the outer hood panel 18 and downward toward the inner hood panel 20 from the flat portion 38 to a pinch feature 46. The pinch feature 46 is U-shaped having a bend 48 that forms a recess 50 that is sides to receive an edge 52 of a rear portion 54 of the inner hood panel 20. The slanted portion 44 can aid in guiding the bracket body 34 onto the edge 52 of the inner hood panel 20 and a front bend 55 of the pinch feature 46 can provide a datum for use in positioning the anti-rotation bracket 32 during installation. Another flat portion 56 forming a second flat area extends inward/downward from the pinch feature 46 to a terminal edge 57 of the bracket body 34. A connecting structure 58, such as a double-sided adhesive tape, may be used to connect the flat portion 56 to the rear portion 54 of the inner hood panel 20. In another embodiment, the connecting structure 58 may be a fastener, clip or other suitable connector to connect the bracket body 34 to the inner hood panel 20. The connecting structure 58 can also inhibit rotation of the anti-flutter bracket 32 into a cavity 60 formed between the inner and outer hood panels 20 and 18.

In some embodiments, one or more reinforcement ribs 62 and 64 may extend from the pinch feature 46 to the flat portion 38, along the slanted portion 44 to reinforce the longitudinal positions of the pinch feature 46 and the flat portion 38 and to help maintain a constant force against the outer hood panel 18. For example, an array of the reinforcement ribs 62 and 64 may be provided that are space-apart in the lateral direction extending into the page.

It should now be understood that the embodiments described herein provide for anti-flutter brackets that can be used to reduce vibrations (e.g., flutter) between the outer and inner hood panels of a hood assembly and reduce vehicle noise. The anti-flutter brackets can be slid between the outer and inner hood panels and guided into place using the shape of the bracket body and installed using a connection feature, such as double-sided tape or fasteners. The bracket body can be formed as a single, monolithic structure with the energy absorption material and connection structure bonded thereto to provide a single bracket assembly that can be easily slid into place for assembly into the hood assembly.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A hood assembly for a vehicle, the hood assembly comprising:
a hood inner panel;
an outer hood panel connected to the hood inner panel; and
an anti-flutter bracket that includes a bracket body and an energy absorption material that is softer than the bracket body located between the outer hood panel and a first flat area of the bracket body that extends parallel to the outer hood panel.

2. The hood assembly of claim 1, wherein the energy absorption material is bonded only to the bracket body thereby allowing the anti-flutter bracket to move independently of the outer hood panel when there is thermal expansion of the outer hood panel.

3. The hood assembly of claim 1, wherein the bracket body comprises a second flat area with double sided adhesive tape and a pinch feature that together engage the hood inner panel.

4. The hood assembly of claim 3, wherein the bracket body comprises a reinforcement rib that extends from the pinch feature toward the first flat area.

5. The hood assembly of claim 3, wherein the bracket body includes a slanted portion that extends from the pinch feature to a flat portion that forms the first flat area.

6. The hood assembly of claim 3, wherein the bracket body comprises a flat portion forming a second flat area that extends inward from the pinch feature and alongside the inner hood panel.

7. The hood assembly of claim 6, wherein a connection structure is provided between the second flat area and the inner hood panel.

8. The hood assembly of claim 7, wherein the connection structure comprises double-sided tape.

9. An anti-flutter bracket for controlling vibration within a hood assembly of a vehicle, the anti-flutter bracket comprising:
a bracket body and an energy absorption material that is softer than the bracket body configured to be located between an outer hood panel and a first flat area of the bracket body that is configured to extend parallel to the outer hood panel with the bracket body installed to an inner hood panel.

10. The anti-flutter bracket of claim 9, wherein the energy absorption material is bonded to the bracket thereby.

11. The anti-flutter bracket of claim 9, wherein the bracket body comprises a second flat area with double sided adhesive tape and a pinch feature that together are configured to engage the hood inner panel with the bracket body installed to the inner hood panel.

12. The anti-flutter bracket of claim 11, wherein the bracket body comprises a reinforcement rib that extends from the pinch feature toward the first flat area.

13. The anti-flutter bracket of claim 11, wherein the bracket body includes a slanted portion that extends from the pinch feature to a flat portion that forms the first flat area.

14. The anti-flutter bracket of claim 11, wherein the bracket body comprises a flat portion forming a second flat area that extends from the pinch feature and is configured to extend alongside the inner hood panel with the bracket body installed to the inner hood panel.

15. The anti-flutter bracket of claim 14, wherein a connection structure is provided on the second flat area and configured to be located between the second flat area and the inner hood panel with the bracket body installed to the inner hood panel.

16. The anti-flutter bracket of claim 15, wherein the connection structure comprises double-sided tape.

17. A method of controlling vibration in a hood assembly of a vehicle, the method comprising:
connecting an anti-flutter bracket to an inner hood panel of the hood assembly; and
bracing an energy absorption material carried by the anti-flutter bracket against an outer hood panel of the hood assembly, the energy absorption material formed of a material that is softer than a bracket body that carries the energy absorption material.

18. The method of claim 17 further comprising bonding the energy absorption material to only the bracket body and not to the outer hood panel.
